(19) United States
(12) Patent Application Publication
(10) Pub. No.: US 2025/0158749 A1
(43) Pub. Date: May 15, 2025

(54) TRANSACTION RESPONSE AGGREGATION FOR NETWORK DATA COMMUNICATION

(71) Applicant: Microsoft Technology Licensing, LLC, Redmond, WA (US)

(72) Inventors: Yalcin YILMAZ, Sunnyvale, CA (US); Monica Man Kay TANG, Santa Clara, CA (US)

(73) Assignee: Microsoft Technology Licensing, LLC, Redmond, WA (US)

(21) Appl. No.: 18/508,070

(22) Filed: Nov. 13, 2023

(51) Int. Cl. H04L 1/1607

(52) U.S. Cl. CPC H04L 1/1607

(57) ABSTRACT

A method for network data communication includes, at an initiator subsystem, generating a data stream including a series of n transaction requests for delivery to two or more target subsystems via a network fabric. The series of n transaction requests are transmitted to the two or more target subsystems. An initiator aggregation controller transmits (n−1) preliminary request responses to the initiator subsystem for a first (n−1) transaction requests of the series of n transaction requests. The initiator aggregation controller receives target-specific aggregated responses to the data stream corresponding to each of the two or more target subsystems. Upon receiving the target-specific aggregated responses corresponding to each of the two or more target subsystems, the initiator aggregator controller transmits an aggregated stream response to the initiator subsystem.

### BACKGROUND

In a computer network environment, one entity (e.g., an “initiator”) may generate a stream of data transaction requests for delivery to, and fulfillment by, one or more other entities (e.g., “targets”) in the same network. Such transaction requests may include write requests, for example. In many networking scenarios, the initiator expects to receive a response from each target for each individual transaction request in the data stream—e.g., such as an acknowledgement that the transaction request was successfully fulfilled.

### SUMMARY

A method for network data communication includes, at an initiator subsystem, generating a data stream including a series of n transaction requests for delivery to two or more target subsystems via a network fabric. The series of n transaction requests are transmitted to the two or more target subsystems. An initiator aggregation controller transmits (n−1) preliminary request responses to the initiator subsystem for a first (n−1) transaction requests of the series of n transaction requests. The initiator aggregation controller receives target-specific aggregated responses to the data stream corresponding to each of the two or more target subsystems. Upon receiving the target-specific aggregated responses corresponding to each of the two or more target subsystems, the initiator aggregator controller transmits an aggregated stream response to the initiator subsystem.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A and 1B schematically illustrate transmission of a data stream over a computer network from an initiator subsystem to two or more target subsystems.

FIGS. 2A and 2B illustrate an example method for network data communication.

FIGS. 3A-3F schematically illustrate transaction response aggregation in a computer network environment.

FIG. 4 schematically shows an example computing system.

### DETAILED DESCRIPTION

In some computer networking environments, an initiator subsystem generates a data stream that includes a number of transaction requests (e.g., write requests) for delivery to, and fulfillment by, a number of target subsystems. This may occur in multicast or broadcast data transmission scenarios, for instance. As used herein, an “initiator subsystem” describes any physical or virtualized entity within a network environment that generates transaction requests for transmission to two or more “target subsystems,” which take the form of any suitable physical or virtualized network entities that receive and fulfill such transaction requests.

In some examples, the initiator and target subsystems are separate computing devices that communicate over a suitable local or wide-area computer network, such as the Internet. Additionally, or alternatively, the initiator and target subsystems may include different subcomponents of the same computing device. For instance, as will be described in more detail below, any or all of the network components described herein may in some examples be implemented as part of a network-on-chip (NoC) system.

When sending transaction requests to the target subsystems, the initiator subsystem generally expects to receive different transaction responses for each transaction request from each target subsystem. However, this can produce a large volume of response traffic, particularly when the data stream includes a relatively large number (e.g., thousands) of transaction requests, and is delivered to several target subsystems. In such cases, the volume of transaction responses transmitted from the target subsystems back to the initiator subsystem can saturate the network's available bandwidth, and can require significant compute resources to coordinate network routing and switching operations. In one example scenario, if the data stream includes a series of 100 transaction requests for delivery to four target subsystems, the initiator will expect to receive 100 transaction responses from each target subsystem, for a total of 400 transaction responses received at the initiator subsystem.

As such, the present disclosure is directed to techniques for aggregating transaction responses to a data stream. Specifically, an initiator subsystem generates a data stream including a series of n transaction requests, where n is any suitable positive integer, and transmits the transaction requests to two or more target subsystems. The initiator subsystem is communicatively coupled with an initiator aggregation controller, while the target subsystems are communicatively coupled with a target aggregation controller.

Notably, according to the techniques described herein, the initiator subsystem does not receive individual transaction responses for each transaction request from the different target subsystems. Instead, as the transaction requests are transmitted, the initiator aggregation controller provides preliminary request responses for a first (n−1) transaction requests of the data stream to the initiator subsystem. These preliminary request responses could be described as placeholder responses that satisfy the initiator subsystem's expectation that it will receive responses for each transaction request, although are not actually generated by the target subsystems to which the transaction requests are transmitted.

Meanwhile, as the target subsystems receive transaction requests, each target subsystem generates corresponding transaction responses. These may include, for instance, acknowledgements that the requests were fulfilled, error reports, and/or any other pertinent information for the transaction requests. However, these transaction responses are dropped by the target aggregation controller—in other words, they are not transmitted over the network fabric for delivery to the initiator subsystem. Rather, information about the generated responses is aggregated at the target aggregation controller.

Once a given target subsystem has responded to every transaction request of the data stream, the target aggregation controller transmits a target-specific aggregated response to the initiator subsystem, which may include any pertinent information included in any of the transaction responses dropped by the target aggregation controller. The target-specific aggregated responses for each target subsystem are received at the initiator aggregation controller, which then provides a single aggregated stream response back to the initiator subsystem. In this manner, the initiator subsystem still receives an expected number of transaction responses to the data stream, and still receives any pertinent information (e.g., error reports) output by the target subsystems in response to the data stream. However, the number of actual transaction responses transmitted over the network fabric is significantly reduced. This beneficially conserves network bandwidth. Furthermore, by reducing the amount of network traffic, the amount of electrical power consumed by network hardware devices, as well as the amount of heat produced by such devices, is reduced.

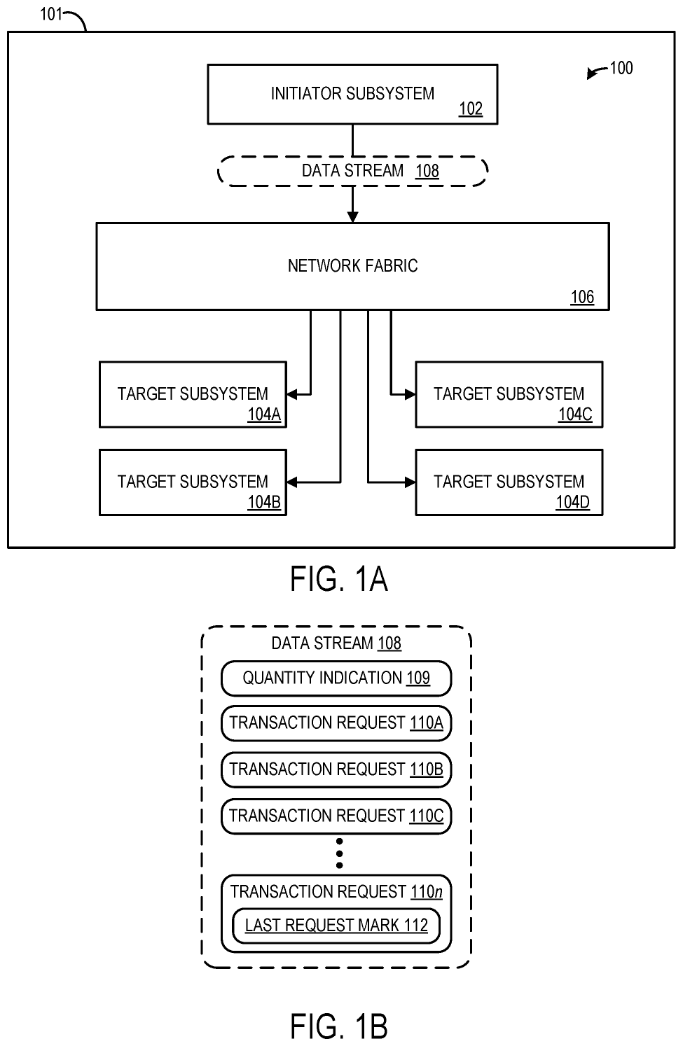

FIG. 1 schematically illustrates transmission of a data stream in an example computer network 100. Network 100 takes the form of any suitable computer network environment. For instance, as discussed above, the computer network may in some cases take the form of a suitable local or wide area network used to communicatively couple multiple different computing devices. In some examples, the computer network includes the internet, and the initiator and target subsystems are different computing devices communicating over the internet.

Alternatively, in some examples, the initiator subsystem, target subsystems, and other network components described herein are implemented as components of a network-on-chip (NoC) system. A NoC system is a specialized communication architecture used in integrated circuits, particularly in complex System-on-Chip (SoC) designs. It replaces traditional bus-based communication with a network of interconnected nodes. Each node typically represents a processing unit, memory element, or other on-chip component. These nodes are linked together by a network of communication channels and routers, which may collectively comprise a “network fabric” as used herein. This is the case in FIG. 1A, where computer network 100 is implemented in NoC 101.

In FIG. 1A, an initiator subsystem 102 is communicatively coupled with a plurality of target subsystems 104A-D via a network fabric 106. Four different target subsystems are shown in FIG. 1A, although it will be understood that this is non-limiting. In general, according to the techniques described herein, a data stream may be transmitted to any suitable number of two or more target subsystems.

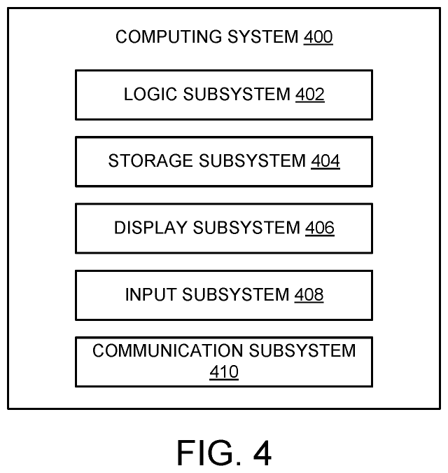

As discussed above, the “initiator subsystem” and “target subsystems” take the form of any physical or virtualized network entities configured to exchange transaction requests and transaction responses. For instance, the initiator and target subsystems may include entire computing devices, computer hardware components (e.g., logic devices, storage devices), virtual components (e.g., containers, virtual machines), or other suitable entities. In some examples, an initiator subsystem, target subsystem, aggregation controller, and/or any other network component described herein may be implemented as computing system 400 described below with respect to FIG. 4. Additionally, or alternatively, any or all of the network components described herein may be implemented via one or more subcomponents of computing system 400—e.g., as logic subsystem 402 and/or storage subsystem 404.

It will be understood that the terms “initiator” and “target” are applied relative to one individual data stream, and that the same device or hardware component can serve as both an initiator and a target at different times, or at the same time. For instance, a computing device may generate a data stream and therefore serve as an “initiator,” while simultaneously serving as the “target” for a different data stream.

Similarly, it will be understood that “transaction requests” take the form of any suitable data packets, frames, or other type of data structure that is transmitted from an initiator subsystem to a target subsystem, and that requests some type of operation to be performed by the target subsystem. For instance, transaction requests may include write requests, and/or other suitable requests. Such requests may be formatted and encoded in any suitable way, using any suitable standard or custom network protocols.

The “network fabric” over which the transaction requests are transmitted takes any suitable form. In general, a network fabric refers to the collection of physical and virtual network components that facilitate exchange of data between different network nodes—e.g., initiator and target subsystems. The network fabric may include any or all of network switches, routers, cables, interconnects, virtual local area networks (VLANs), software-defined networks (SDNs), etc., as examples.

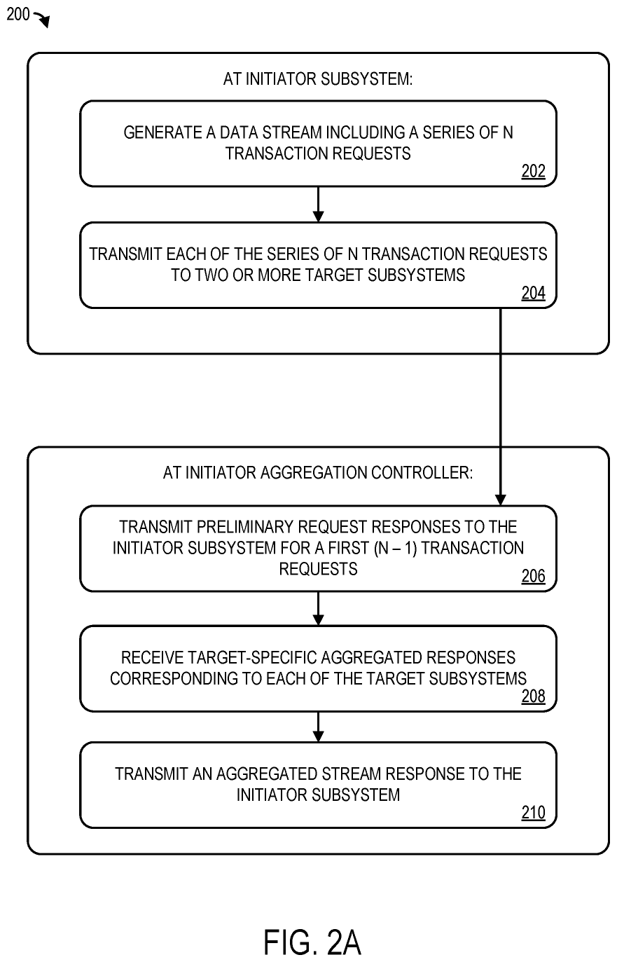

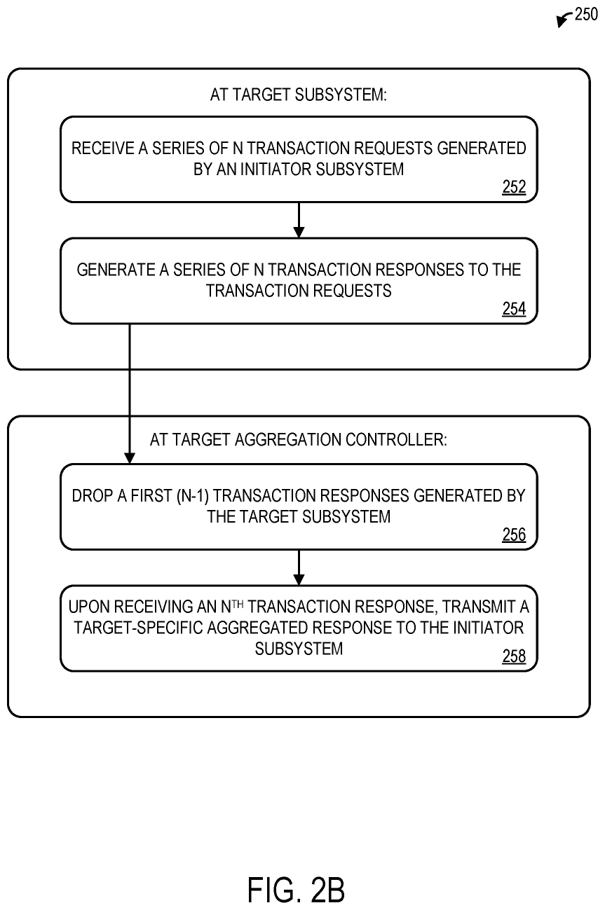

As discussed above, transmission of a data stream to two or more target subsystems can produce a significant amount of network traffic when the target subsystems send individual responses to transaction requests of the data stream. Accordingly, FIG. 2 illustrates an example method 200 for transaction response aggregation in a computer network. Steps of method 200 are generally described as being performed by an initiator subsystem and an initiator aggregation controller. However, it will be understood that method 200 may be performed by any suitable computing system of one or more computing devices. Any computing device implementing steps of method 200 may have any suitable capabilities, hardware configuration, and form factor. In some examples, method 200 is implemented by computing system 400 described below with respect to FIG. 4.

At 202, method 200 includes an initiator subsystem generating a data stream including a series of n transaction requests. At 204, method 200 includes transmitting each of the series of n transaction requests to the two or more target subsystems. In FIG. 1A, the initiator subsystem is generating a data stream 108 for transmission over network fabric 106 to the target subsystems 104A-D. The data stream is schematically represented in more detail with respect to FIG. 1B. As shown, the data stream includes a series of transaction requests, including transaction requests 110A, 110B, 110C, and 110n. It will be understood that a data stream may include any suitable number of one or more transaction requests, referred to herein as a series of n transaction requests. Such transaction requests may be transmitted sequentially with any suitable frequency, and/or two or more transaction requests may in some cases be transmitted simultaneously.

Furthermore, the data stream may be generated at any suitable time, for any suitable reason, and include any suitable data. In some examples, the data stream is transmitted to multiple target subsystems as a multicast stream. In other examples, the data stream may be transmitted via broadcast. In some examples, the data stream may be generated by one or more software applications executed by the initiator subsystem. It will be understood that various types of transaction requests may be transmitted over a computer network for a wide variety of reasons and can include arbitrary computer data. As such, the present disclosure is focused on aggregating responses to transaction requests in order to conserve network bandwidth and other computational resources, and is generic as to the specific content of the data that is transmitted.

In some examples, transmitting the data stream includes transmitting a transaction quantity indication. In the example of FIG. 1B, data stream 108 includes a transaction quantity indication 109. The transaction quantity indication indicates a quantity of the n transaction requests in the data stream. For instance, if the data stream includes 100 separate transaction requests, this may be specified by the transaction quantity indication. In some cases, the transaction quantity indication is transmitted relatively early in the data stream. For instance, if the transaction quantity is already known, then the transaction quantity indication may be transmitted as part of the first packet of the data stream. In other cases, the transaction quantity indication may be sent as part of a last network packet—e.g., the initiator subsystem may count each transaction request that is generated, and once the last request is generated, the final transaction count is included in the last packet. The transaction quantity indication may serve to notify the initiator aggregation controller of the number of preliminary request responses to transmit, and/or notify the target aggregation controller of the number of transaction responses that should be dropped before sending a target-specific aggregated response.

Additionally, or alternatively, in some examples, the initiator subsystem marks an n^{th} transaction request of the series of n transaction requests as being a last transaction request of the data stream. In the example of FIG. 1B, a last transaction request 110n of the data stream is marked with a last request mark 112. Such a marking may take any suitable form—e.g., such as a particular bit being set in a predefined data field of the last transaction request. The last request marking may, for instance, indicate to the initiator aggregator controller that it should discontinue sending preliminary request responses, and/or indicate to the target aggregation controller that the data stream is ending, and therefore that aggregated transaction responses should be transmitted.

Additionally, or alternatively, in some examples, the initiator aggregation controller may count outgoing transaction requests, until it receives a network packet marked as being the last network packet. At this time, the initiator aggregation controller may transmit a transaction quantity indication to the target aggregation controller that specifies the counted number of transaction requests. Additionally, or alternatively, the initiator aggregation controller may mark the last transaction request as being the final request—e.g., based on a transaction quantity indication reported by the initiator subsystem.

As discussed above, the initiator subsystem generally expects that it will receive a response to each transaction request. However, according to the techniques described herein, the individual transaction responses generated by the target subsystems are not delivered to the initiator subsystem. Instead, returning briefly to FIG. 2, at 206, method 200 includes the initiator aggregation controller transmitting (n−1) preliminary request responses to the initiator subsystem for the first (n−1) transaction requests of the series of n transaction requests.

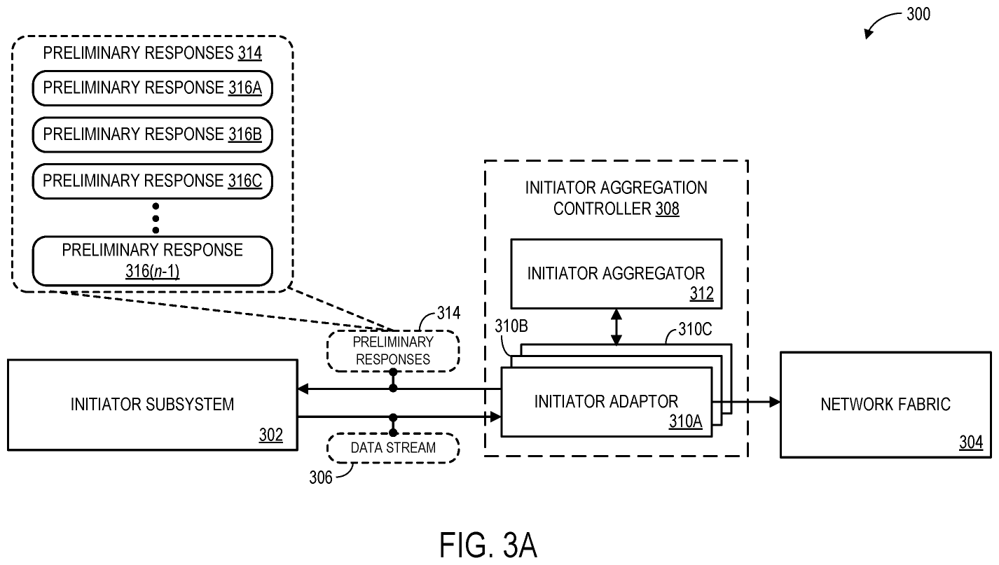

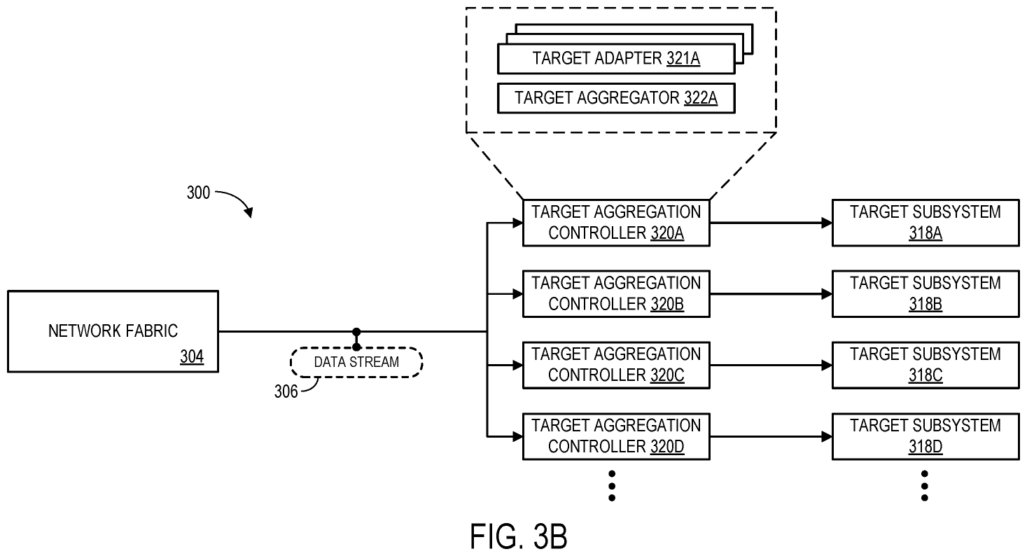

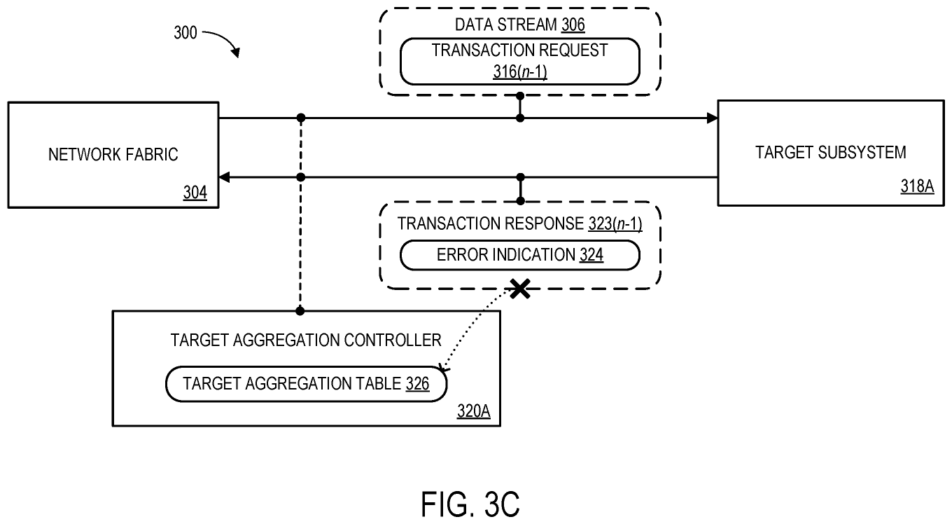

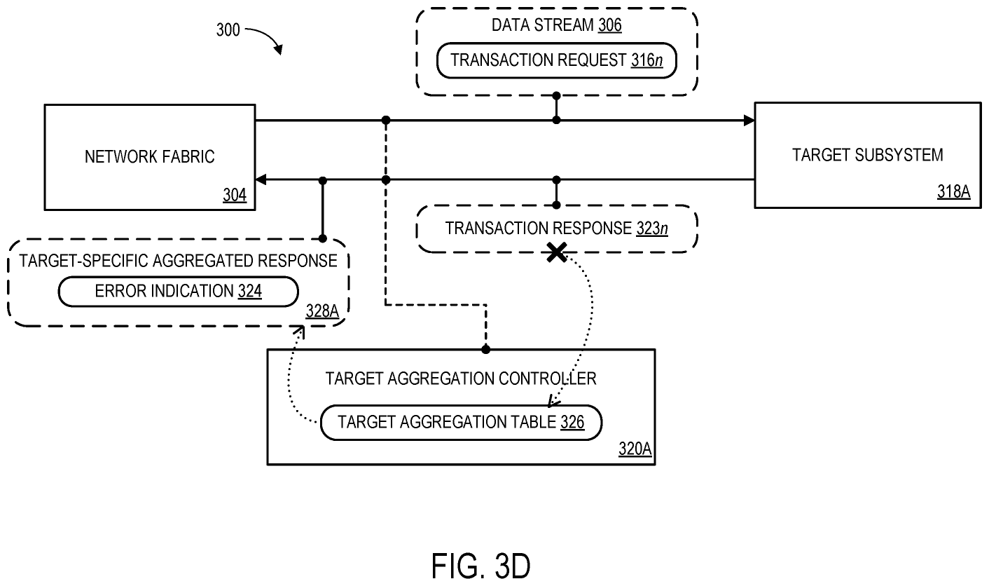

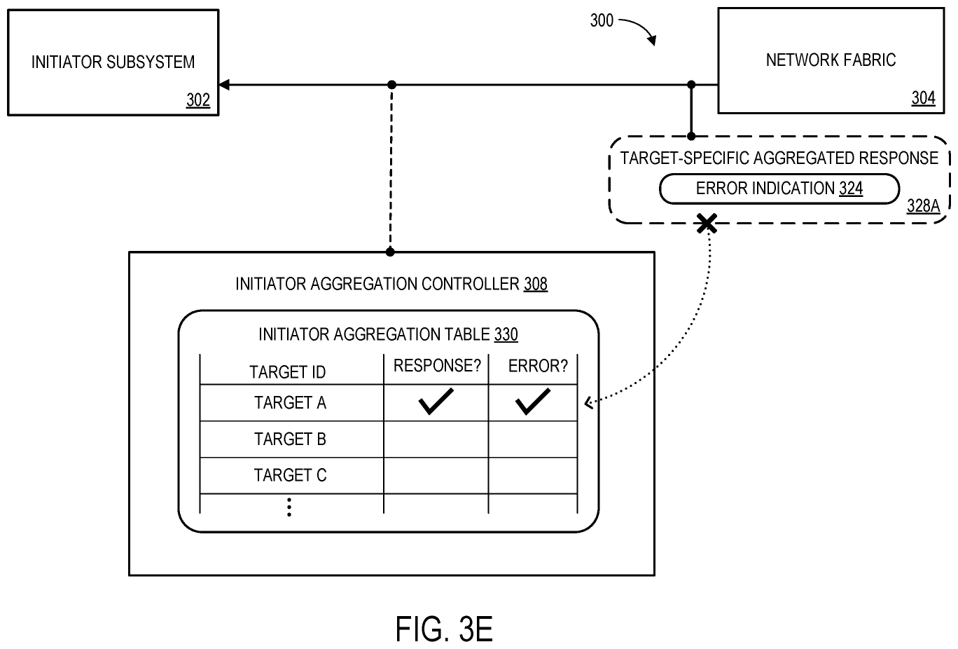

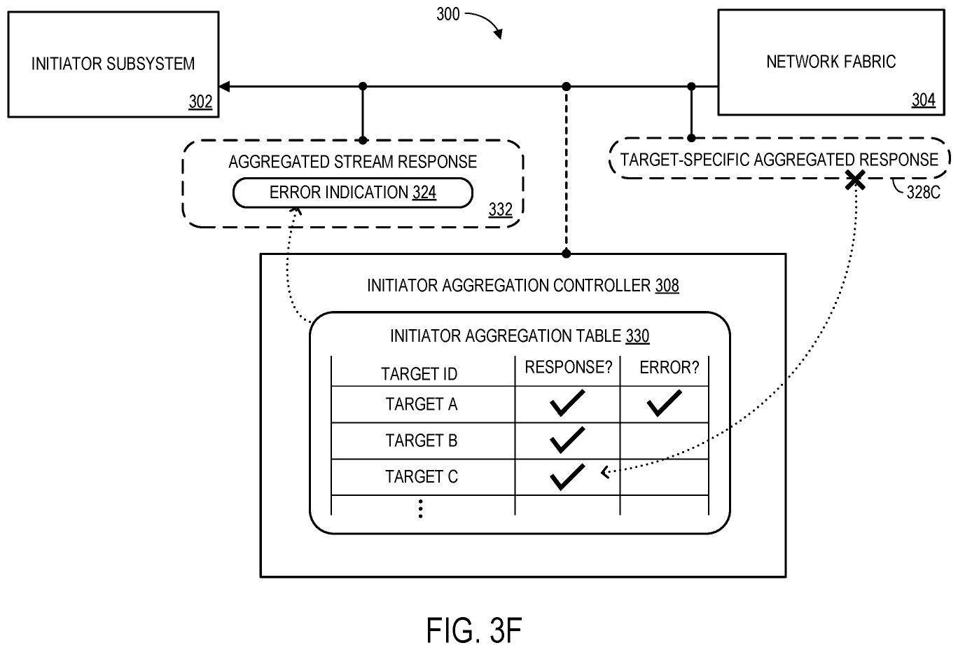

This is schematically illustrated with respect to FIG. 3A, showing another example computer network 300, in which an initiator subsystem 302 is configured to transmit transaction requests over a network fabric 304. As shown, the initiator subsystem is transmitting a data stream 306, which includes a series of n transaction requests as described above.

In the example of FIG. 3A, network 300 additionally includes an initiator aggregation controller 308. As used herein, an “initiator aggregation controller” may be implemented as one or more different hardware devices. In other words, in some examples, an “initiator aggregation controller” takes the form of a single hardware logic component (e.g., implemented as logic subsystem 402 described with respect to FIG. 4) that performs initiator-side aggregation functions as described herein. Alternatively, functions described as being performed by the initiator aggregation controller may be distributed between two or more hardware logic components working cooperatively. In the example of FIG. 3A, the initiator aggregation controller 308 comprises an initiator adapter 310A and an initiator aggregator 312.

In general, an initiator adapter takes the form of any suitable collection of one or more network hardware components used to communicatively couple the initiator subsystem with other components in the computer network. For instance, in some examples, an initiator adapter is a network adapter of the initiator subsystem. In some examples, the initiator aggregation controller includes two or more initiator adapters corresponding to two or more network ports over which the initiator subsystem transmits the series if n transaction requests. This is the case in FIG. 3A, where initiator aggregation controller 308 additionally includes initiator adapters 310B and 310C. However, it will be understood that the techniques described herein are also applicable to scenarios where only one network port and initiator adapter are used.

When included, an “initiator aggregator” may be used to track whether aggregated transaction responses have been received that correspond to different target subsystems. The initiator aggregator takes the form of any suitable computer hardware component communicatively coupled with the initiator adapters. As initiator adapters receive transaction requests for transmission over the network fabric, and receive aggregated responses in return, the initiator adapters provide updates to the initiator aggregator. It will be understood that each of the initiator adapters and initiator aggregator may be implemented in any suitable way—e.g., via any or all of the components of computing system 400 described below.

According to the techniques described herein, as the initiator subsystem transmits the data stream, the initiator aggregation controller transmits (n−1) preliminary request responses for the first (n−1) transaction requests. This is schematically illustrated in FIG. 3A, where the initiator aggregation controller provides preliminary request responses 314 back to the initiator subsystem 302. As shown, this includes preliminary responses 316A-316(n−1). A “preliminary request response” may take any suitable form, having any suitable encoding, formatting, and content. The preliminary request responses serve to satisfy the initiator subsystem's expectation that it will receive responses to each of the transaction requests in the data stream. As such, the preliminary request responses will typically use similar formatting and encoding to the actual transaction responses generated by the target subsystems, although do not include data generated by the target subsystems. Rather, as discussed above, the preliminary request responses function as placeholders.

Method 200 continues with initiator-side aggregation operations that are performed as aggregated responses to the data stream are received. Turning now to FIG. 2B, another example method 250 is illustrated that focuses on target-side aggregation operations. Steps of method 250 may occur at least partially concurrently with steps of method 200—e.g., as transaction requests are transmitted, transaction responses may be generated and aggregated. As with method 200, steps of method 250 are generally described as being performed by a target subsystem and a target aggregation controller. However, it will be understood that method 250 may be performed by any suitable computing system of one or more computing devices. Any computing device implementing steps of method 250 may have any suitable capabilities, hardware configuration, and form factor. In some examples, method 250 is implemented by computing system 400 described below with respect to FIG. 4.

At 252, method 250 includes receiving a series of n transaction requests of a data stream generated by an initiator subsystem and transmitted over a network fabric. This is schematically illustrated with respect to FIG. 3B, showing target-side portions of computer network 300. As shown, data stream 306 is received by a plurality of target subsystems 318A-318D. It will be understood that the computer network may include any suitable number of two or more target subsystems. Furthermore, the different target subsystems may have any suitable relationship with respect to one another—e.g., they may be collocated in the same computing device, or arbitrarily distributed around the world.

As shown, the plurality of target subsystems are communicatively coupled with respective target aggregation controllers 320A-D. Similar to the initiator aggregation controller described above, a “target aggregation controller” may be implemented as one or more different hardware devices. In other words, in some examples, a “target aggregation controller” takes the form of a single hardware logic component (e.g., implemented as logic subsystem 402 described with respect to FIG. 4) that performs target-side aggregation functions as described herein. Alternatively, functions described as being performed by the target aggregation controller may be distributed between two or more hardware logic components working cooperatively. For instance, in the example of FIG. 3B, target aggregation controller 320A is implemented via a target adapter 321A working cooperatively with a target aggregator 322A. In some examples, two or more target adapters are used per target subsystem, such as is shown in FIG. 3B. The other target aggregation controllers may similarly be implemented via corresponding target adapters and target aggregators.

In general, a target adapter takes the form of any suitable collection of one or more network hardware components used to communicatively couple a given target subsystem with other components in the computer network. For instance, in some examples, a target adapter is a network adapter of the target subsystem, and thus each target subsystem may include its own corresponding target adapter.

By contrast, when included, a “target aggregator” may be used to track the number of transaction responses generated by a particular target subsystem that are dropped, in order to determine when a target-specific aggregated response should be transmitted. The target aggregator takes the form of any suitable computer hardware component communicatively coupled with the one or more target adapters. As target adapters receive transaction responses subsystems, and drop such responses, the target adapters provide updates to the target aggregator. It will be understood that each of the target adapters and target aggregator may be implemented in any suitable way—e.g., via any or all of the components of computing system 400 described below.

Returning briefly to FIG. 2B, at 254, method 250 includes generating a series of n transaction responses to the transaction requests of the data stream. This is schematically illustrated with respect to FIG. 3C, again showing target-side aspects of computer network 300. In this example, a target subsystem 318A is continuing to receive data stream 306, including an individual transaction request 316(n−1). Transaction requests 316A-C shown in FIG. 3A have already been received by the target subsystem. While FIG. 3C only shows target subsystem 318A, it will be understood that the data stream is similarly received by target subsystems 318B-D shown in FIG. 3B, which may similarly generate responses to the transaction requests in the data stream.

In FIG. 3C, the target subsystem has generated a transaction response 323(n−1) in response to transaction request 316(n−1). It will be understood that the transaction response is formatted and encoded in any suitable way, and includes any suitable content depending on the specific implementation. As discussed above, the present disclosure is primarily concerned with aggregation of transaction responses in a data stream, and not to the specific content of the transaction responses.

In general, a transaction response serves as an indication to the initiator subsystem that the transaction request was received. In some examples, a transaction response may indicate that the corresponding transaction request was successfully fulfilled. Additionally, or alternatively, the transaction response may specify that an error occurred while the target subsystem attempted to fulfill the transaction request. In the example of FIG. 3C, transaction response 323(n−1) includes an error indication 324, indicating that an error was reported by the target system while it attempted to fulfill transaction request 316(n−1). It will be understood that the error indication takes any suitable form—e.g., as a unique error code.

Returning briefly to FIG. 2B, at 256, method 250 includes the target aggregation controller dropping a first (n−1) transaction responses generated by the target subsystem in response to the first (n−1) transaction requests of the series of n transaction requests. This is also schematically illustrated with respect to FIG. 3C, where transaction response 323(n−1) is dropped by the target aggregation controller 320A, and is not transmitted over the network fabric 304 back to initiator-side components of computer network 300. This is indicated by the X symbol shown over transaction response 323(n−1). Though not shown in FIG. 3C, it will be understood that earlier transaction responses generated by the target subsystem in response to earlier transaction requests (e.g., transaction responses 323A-C corresponding to transaction requests 316A-C) are similarly dropped by the target aggregation controller.

Instead, information pertaining to transaction response 323(n−1) as well as any earlier transaction responses generated by the target subsystem, is aggregated by the target aggregation controller. This can include any suitable information, which may be organized and stored by the target aggregation controller in any suitable way. Any information described herein as being stored by the target aggregation controller may be stored by any or all of the devices shown in FIG. 3B collectively implementing the target aggregation controller—e.g., in some cases, information is aggregated at the target aggregator 322 of target aggregation controller 320A.

In some examples, the target aggregation controller maintains a table corresponding to the data stream. In FIG. 3C, target aggregation controller 320A maintains a target aggregation table 326. As examples, the target aggregation table may include fields indicating an expected quantity of the n transaction requests (e.g., as previously reported by the initiator subsystem, such as via quantity indication 109 shown in FIG. 1B), a field indicating a quantity of transaction responses dropped by the target aggregation controller, and a field indicating whether an error was reported by the target subsystem. It will be understood that this is non-limiting, and that the target aggregation controller may include any suitable information in addition to, or instead of, the specific types of information listed above. Furthermore, a target aggregation controller may maintain such information (e.g., additional target aggregation tables) for any suitable number of ongoing data streams, which may be distinguished in any suitable way—e.g., via different unique data stream identifiers corresponding to each target aggregation table.

Returning briefly to FIG. 2B, at 258, method 250 includes the target aggregation controller transmitting a target-specific aggregated response to the initiator aggregation controller, upon receiving an n^{th} transaction response generated by the target subsystem in response to an n^{th} transaction request of the data stream. This is schematically illustrated with respect to FIG. 3D, again showing target-side components of the computer network 300. As shown, target subsystem 318A continues to receive data stream 306, which ends with the last transaction request of the data stream, transaction request 316n. In response, target subsystem 318A generates an n^{th} transaction response 323n, which is also dropped by the target aggregation controller.

However, because the target subsystem has generated transaction responses for every transaction request in the stream (e.g., as determined based on the target aggregation controller dropping n responses, and/or because the last-received transaction request is marked as the last transaction request of the stream), the target aggregation controller generates and transmits a target-specific aggregated response 328A over the network fabric 304. The target-specific aggregated response includes any or all pertinent information reported by the target system in any of the series of n transaction responses generated by the target subsystem.

For instance, in the example of FIG. 3D, the target-specific aggregated response again includes error indication 324, generated by the target subsystem in response to one of the prior transaction requests of the data stream. In other words, the target-specific aggregated response corresponding to target subsystem 318A indicates that an error was reported by the target subsystem in response to a prior transaction of the series of n transaction requests. The target-specific aggregated response may include any suitable number of such error indications. For instance, in some examples, the target-specific aggregated response includes any error indications output by the target subsystem. In other examples, the target-specific aggregated response may include only one such error indication—e.g., corresponding to a most serious error output by the target subsystem. Furthermore, the target-specific aggregated response may include any suitable information in addition to, or instead of, error indications.

In any case, once generated, the target-specific aggregated response is transmitted by the target aggregation controller to the initiator side of the computer network. As such, returning briefly to FIG. 2A, at 208, method 200 includes the initiator aggregation controller receiving target-specific aggregated responses to the data stream, corresponding to each of the two or more target subsystems. Notably, the target-specific aggregated responses are not all necessarily received at the same time. Rather, different target subsystems may take different amounts of time to receive, fulfill, and respond to the transaction requests of the data stream. As such, different target-specific aggregated responses may be received at the initiator aggregation controller at different times.

This is schematically illustrated with respect to FIG. 3E, showing initiator-side components of computer network 300. As shown, initiator aggregation controller 308 receives target-specific aggregated response 328A from the target aggregation controller via network fabric 304. However, this target-specific aggregated response is not delivered to initiator subsystem 302. Rather, the target-specific aggregated response is dropped by the initiator aggregation controller, and information pertinent to the target-specific aggregated response is aggregated by the initiator aggregation controller.

As discussed above with respect to the target aggregation controller, the information aggregated by the initiator aggregation controller can include any suitable information, which may be organized and stored in any suitable way. Any information described herein as being stored by the initiator aggregation controller may be stored by any or all of the devices shown in FIG. 3A collectively implementing the initiator aggregation controller—e.g., in some cases, information is aggregated at the initiator aggregator 312 of initiator aggregation controller 308.

In some examples, the initiator aggregation controller maintains a table corresponding to the data stream. In FIG. 3E, initiator aggregation controller 308 maintains an initiator aggregation table 330. As examples, the initiator aggregation table may include fields indicating whether target-specific aggregated responses have been received from each of the two or more target subsystems, and a field indicating whether an error was reported by the two or more target subsystems. It will be understood that this is non-limiting, and that the initiator aggregation controller may include any suitable information in addition to, or instead of, the specific types of information listed above. Furthermore, an initiator aggregation controller may maintain such information (e.g., additional initiator aggregation tables) for any suitable number of ongoing data streams, which may be distinguished in any suitable way—e.g., via unique data stream identifiers corresponding to each initiator aggregation table.

This process is schematically illustrated with respect to FIG. 3E. As shown, the initiator aggregation controller receives target-specific aggregated response 328A. While the response itself is dropped by the initiator aggregation controller, the initiator aggregation table is updated to reflect that target subsystem 318A has provided a target-specific aggregated response, and that the target-specific aggregated response included an error. However, at this time, not all of the target-specific aggregated responses have been received.

Returning briefly to FIG. 2A, at 210, method 200 includes the initiator aggregation controller transmitting an aggregated stream response to the initiator subsystem upon receiving the target-specific aggregated responses from each of the two or more target subsystems. This is schematically illustrated with respect to FIG. 3F, where initiator aggregation controller 308 is receiving another target-specific aggregated response 328C. In this scenario, target-specific aggregated response 328C is the last target-specific aggregated response—in other words, at this point, aggregated responses corresponding to each target subsystem have been received.

As such, the initiator aggregation controller generates an aggregated stream response 332, which is transmitted to the initiator subsystem 302. In this manner, the initiator subsystem receives an aggregated version of the transaction responses generated by each of the target systems to which the data stream was transmitted. Furthermore, in combination with the preliminary request responses previously transmitted by the initiator aggregation controller, the initiator subsystem receives an expected number of responses to the data stream.

As with the target-specific aggregated responses, the aggregated stream response may include any suitable information. For instance, in the example of FIG. 3F, the aggregated stream response again includes the error indication 324, generated by target subsystem 318A. It will be understood that the aggregated stream response may include any suitable number of error indications, which may include any or all of the errors reported by the different target subsystems. In some cases, errors may be prioritized based on severity. Furthermore, the aggregated stream response may include any suitable information in addition to, or instead of, error indications—e.g., acknowledgements, telemetry, and/or unique identifiers.

The methods and processes described herein may be tied to a computing system of one or more computing devices. In particular, such methods and processes may be implemented as an executable computer-application program, a network-accessible computing service, an application-programming interface (API), a library, or a combination of the above and/or other compute resources.

FIG. 4 schematically shows a simplified representation of a computing system 400 configured to provide any to all of the compute functionality described herein. Computing system 400 may take the form of one or more personal computers, network-accessible server computers, tablet computers, home-entertainment computers, gaming devices, mobile computing devices, mobile communication devices (e.g., smart phone), virtual/augmented/mixed reality computing devices, wearable computing devices, Internet of Things (IoT) devices, embedded computing devices, and/or other computing devices.

Computing system 400 includes a logic subsystem 402 and a storage subsystem 404. Computing system 400 may optionally include a display subsystem 406, input subsystem 408, communication subsystem 410, and/or other subsystems not shown in FIG. 4.

Logic subsystem 402 includes one or more physical devices configured to execute instructions. For example, the logic subsystem may be configured to execute instructions that are part of one or more applications, services, or other logical constructs. The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 404 includes one or more physical devices configured to temporarily and/or permanently hold computer information such as data and instructions executable by the logic subsystem. When the storage subsystem includes two or more devices, the devices may be collocated and/or remotely located. Storage subsystem 404 may include volatile, nonvolatile, dynamic, static, read/write, read-only, random-access, sequential-access, location-addressable, file-addressable, and/or content-addressable devices. Storage subsystem 404 may include removable and/or built-in devices. When the logic subsystem executes instructions, the state of storage subsystem 404 may be transformed—e.g., to hold different data.

Aspects of logic subsystem 402 and storage subsystem 404 may be integrated together into one or more hardware-logic components. Such hardware-logic components may include program- and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

When included, display subsystem 406 may be used to present a visual representation of data held by storage subsystem 404. This visual representation may take the form of a graphical user interface (GUI). Display subsystem 406 may include one or more display devices utilizing virtually any type of technology. In some implementations, display subsystem may include one or more virtual-, augmented-, or mixed reality displays.

When included, input subsystem 408 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 410 may be configured to communicatively couple computing system 400 with one or more other computing devices. Communication subsystem 410 may include wired and/or wireless communication devices compatible with one or more different communication protocols. The communication subsystem may be configured for communication via personal-, local- and/or wide-area networks.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

In an example, a method for network data communication comprises: at an initiator subsystem, generating a data stream including a series of n transaction requests for delivery to two or more target subsystems via a network fabric; at the initiator subsystem, transmitting each of the series of n transaction requests over the network fabric to the two or more target subsystems; at an initiator aggregation controller communicatively coupled with the initiator subsystem, for a first (n−1) transaction requests of the series of n transaction requests, transmitting (n−1) preliminary request responses to the initiator subsystem; at the initiator aggregation controller, receiving, via the network fabric, target-specific aggregated responses to the data stream corresponding to each of the two or more target subsystems; and at the initiator aggregation controller, upon receiving the target-specific aggregated responses corresponding to each of the two or more target subsystems, transmitting an aggregated stream response to the initiator subsystem. In this example or any other example, the method further comprises, at the initiator subsystem, marking an n^{th} transaction request of the series of n transaction requests as being a last transaction request of the data stream. In this example or any other example, the method further comprises, at the initiator subsystem, transmitting a transaction quantity indication over the network fabric that indicates a quantity of the n transaction requests in the data stream. In this example or any other example, the initiator aggregation controller includes two or more initiator adapters corresponding to two or more network ports over which the initiator subsystem transmits the series of n transaction requests. In this example or any other example, the initiator aggregation controller maintains a table corresponding to the data stream, the table including fields indicating whether target-specific aggregated responses have been received from each of the two or more target subsystems, and a field indicating whether an error was reported by the two or more target subsystems. In this example or any other example, a target-specific aggregated response corresponding to a target subsystem of the two or more target subsystems indicates that an error was reported by the target subsystem in response to a transaction request of the series of n transaction requests. In this example or any other example, the method further comprises, at a target aggregation controller communicatively coupled to a target subsystem of the two or more target subsystems, dropping a first (n−1) transaction responses generated by the target subsystem in response to the first n−1 transaction requests of the series of n transaction requests. In this example or any other example, the method further comprises, at the target aggregation controller, upon receiving an n^{th} transaction response from the target subsystem in response to an n^{th} transaction request of the series of n transaction requests, transmitting a target-specific aggregated response to the initiator aggregation controller. In this example or any other example, the target aggregation controller maintains a table corresponding to the data stream, the table including a field indicating an expected quantity of the n transaction requests, a field indicating a quantity of transaction responses dropped by the target aggregation controller, and a field indicating whether an error was reported by the target subsystem. In this example or any other example, the initiator subsystem, the initiator aggregation controller, and the two or more target subsystems are implemented as subcomponents of a network-on-chip (NoC) system. In this example or any other example, the data stream is a multicast stream.

In an example, a computer network comprises: an initiator subsystem configured to: generate a data stream including a series of n transaction requests for delivery to two or more target subsystems via a network fabric of the computer network; and transmit each of the series of n transaction requests over the network fabric to the two or more target subsystems; and an initiator aggregation controller communicatively coupled with the initiator subsystem, the initiator aggregation controller configured to: for a first (n−1) transaction requests of the series of n transaction requests, transmit (n−1) preliminary request responses to the initiator subsystem; receive, via the network fabric, target-specific aggregated responses to the data stream corresponding to each of the two or more target subsystems; and upon receiving the target-specific aggregated responses corresponding to each of the two or more target subsystems, transmit an aggregated stream response to the initiator subsystem. In this example or any other example, the initiator subsystem is further configured to mark an n^{th} transaction request of the series of n transaction requests as being a last transaction request of the data stream. In this example or any other example, the initiator subsystem is further configured to transmit a transaction quantity indication via the network fabric to the two or more target subsystems, the transaction quantity indication indicating a quantity of the n transaction requests in the data stream. In this example or any other example, the initiator aggregation controller includes two or more initiator adapters corresponding to two or more network ports over which the initiator subsystem transmits the series of n transaction requests. In this example or any other example, the initiator aggregation controller maintains a table corresponding to the data stream, the table including a field indicating whether target-specific aggregated responses have been received from each of the two or more target subsystems, and a field indicating whether an error was reported by the two or more target subsystems. In this example or any other example, a target-specific aggregated response received from a target subsystem of the two or more target subsystems via the network fabric indicates that an error was reported by the target subsystem in response to a transaction request of the series of n transaction requests. In this example or any other example, the computer network further comprises a target aggregation controller communicatively coupled to a target subsystem of the two or more target subsystems, the target aggregation controller configured to drop a first (n−1) transaction responses generated by the target subsystem in response to the first n−1 transaction requests of the series of n transaction requests. In this example or any other example, the target aggregation controller is further configured to, upon receiving an n^{th} transaction response from the target subsystem in response to an n^{th} transaction request of the series of n transaction requests, transmit a target-specific aggregated response to the initiator aggregation controller via the network fabric.

In an example, a method for network data communication comprises: at a target subsystem, receiving a series of n transaction requests of a data stream generated by an initiator subsystem and transmitted over a network fabric, wherein an initiator aggregator controller transmits preliminary request responses to the initiator subsystem for a first (n−1) transaction requests of the series of n transaction requests; at the target subsystem, generating a series of n transaction responses to the initiator subsystem in response to the series of n transaction requests; at a target aggregation controller communicatively coupled to the target subsystem, dropping a first (n−1) transaction responses of the series of n transaction responses transmitted by the target subsystem; and at the target aggregation controller, upon receiving an n^{th} transaction response from the target subsystem in response to an n^{th} transaction request of the series of n transaction requests, transmitting a target-specific aggregated response to the initiator aggregation controller via the network fabric.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for network data communication, comprising:
at an initiator subsystem, generating a data stream including a series of n transaction requests for delivery to two or more target subsystems via a network fabric;
at the initiator subsystem, transmitting each of the series of n transaction requests over the network fabric to the two or more target subsystems;
at an initiator aggregation controller communicatively coupled with the initiator subsystem, for a first (n−1) transaction requests of the series of n transaction requests, transmitting (n−1) preliminary request responses to the initiator subsystem;
at the initiator aggregation controller, receiving, via the network fabric, target-specific aggregated responses to the data stream corresponding to each of the two or more target subsystems; and
at the initiator aggregation controller, upon receiving the target-specific aggregated responses corresponding to each of the two or more target subsystems, transmitting an aggregated stream response to the initiator subsystem.

2. The method of claim 1, further comprising, at the initiator subsystem, marking an n^{th} transaction request of the series of n transaction requests as being a last transaction request of the data stream.

3. The method of claim 1, further comprising, at the initiator subsystem, transmitting a transaction quantity indication over the network fabric that indicates a quantity of the n transaction requests in the data stream.

4. The method of claim 1, wherein the initiator aggregation controller includes two or more initiator adapters corresponding to two or more network ports over which the initiator subsystem transmits the series of n transaction requests.

5. The method of claim 1, wherein the initiator aggregation controller maintains a table corresponding to the data stream, the table including fields indicating whether target-specific aggregated responses have been received from each of the two or more target subsystems, and a field indicating whether an error was reported by the two or more target subsystems.

6. The method of claim 1, wherein a target-specific aggregated response corresponding to a target subsystem of the two or more target subsystems indicates that an error was reported by the target subsystem in response to a transaction request of the series of n transaction requests.

7. The method of claim 1, further comprising, at a target aggregation controller communicatively coupled to a target subsystem of the two or more target subsystems, dropping a first (n−1) transaction responses generated by the target subsystem in response to the first n−1 transaction requests of the series of n transaction requests.

8. The method of claim 7, further comprising, at the target aggregation controller, upon receiving an n^{th} transaction response from the target subsystem in response to an n^{th} transaction request of the series of n transaction requests, transmitting a target-specific aggregated response to the initiator aggregation controller.

9. The method of claim 7, wherein the target aggregation controller maintains a table corresponding to the data stream, the table including a field indicating an expected quantity of the n transaction requests, a field indicating a quantity of transaction responses dropped by the target aggregation controller, and a field indicating whether an error was reported by the target subsystem.

10. The method of claim 1, wherein the initiator subsystem, the initiator aggregation controller, and the two or more target subsystems are implemented as subcomponents of a network-on-chip (NoC) system.

11. The method of claim 1, wherein the data stream is a multicast stream.

12. A computer network, comprising:
an initiator subsystem configured to:
generate a data stream including a series of n transaction requests for delivery to two or more target subsystems via a network fabric of the computer network; and
transmit each of the series of n transaction requests over the network fabric to the two or more target subsystems; and
an initiator aggregation controller communicatively coupled with the initiator subsystem, the initiator aggregation controller configured to:
for a first (n−1) transaction requests of the series of n transaction requests, transmit (n−1) preliminary request responses to the initiator subsystem;
receive, via the network fabric, target-specific aggregated responses to the data stream corresponding to each of the two or more target subsystems; and
upon receiving the target-specific aggregated responses corresponding to each of the two or more target subsystems, transmit an aggregated stream response to the initiator subsystem.

13. The computer network of claim 12, wherein the initiator subsystem is further configured to mark an n^{th} transaction request of the series of n transaction requests as being a last transaction request of the data stream.

14. The computer network of claim 12, wherein the initiator subsystem is further configured to transmit a transaction quantity indication via the network fabric to the two or more target subsystems, the transaction quantity indication indicating a quantity of the n transaction requests in the data stream.

15. The computer network of claim 12, wherein the initiator aggregation controller includes two or more initiator adapters corresponding to two or more network ports over which the initiator subsystem transmits the series of n transaction requests.

16. The computer network of claim 12, wherein the initiator aggregation controller maintains a table corresponding to the data stream, the table including a field indicating whether target-specific aggregated responses have been received from each of the two or more target subsystems, and a field indicating whether an error was reported by the two or more target subsystems.

17. The computer network of claim 12, wherein a target-specific aggregated response received from a target subsystem of the two or more target subsystems via the network fabric indicates that an error was reported by the target subsystem in response to a transaction request of the series of n transaction requests.

18. The computer network of claim 12, further comprising a target aggregation controller communicatively coupled to a target subsystem of the two or more target subsystems, the target aggregation controller configured to drop a first (n−1) transaction responses generated by the target subsystem in response to the first n−1 transaction requests of the series of n transaction requests.

19. The computer network of claim 18, wherein the target aggregation controller is further configured to, upon receiving an n^{th} transaction response from the target subsystem in response to an n^{th} transaction request of the series of n transaction requests, transmit a target-specific aggregated response to the initiator aggregation controller via the network fabric.

20. A method for network data communication, comprising:
at a target subsystem, receiving a series of n transaction requests of a data stream generated by an initiator subsystem and transmitted over a network fabric, wherein an initiator aggregator controller transmits preliminary request responses to the initiator subsystem for a first (n−1) transaction requests of the series of n transaction requests;
at the target subsystem, generating a series of n transaction responses to the initiator subsystem in response to the series of n transaction requests;
at a target aggregation controller communicatively coupled to the target subsystem, dropping a first (n−1) transaction responses of the series of n transaction responses transmitted by the target subsystem; and
at the target aggregation controller, upon receiving an n^{th} transaction response from the target subsystem in response to an n^{th} transaction request of the series of n transaction requests, transmitting a target-specific aggregated response to the initiator aggregation controller via the network fabric.
